(19) United States
(12) Patent Application Publication
(10) Pub. No.: US 2012/0195436 A1
(43) Pub. Date: Aug. 2, 2012

(54) Sound Source Position Estimation Apparatus, Sound Source Position Estimation Method, And Sound Source Position Estimation Program

(75) Inventors: Kazuhiro NAKADAI, Wako-shi (JP); Hiroki MIURA, Wako-shi (JP); Takami YOSHIDA, Wako-shi (JP); Keisuke NAKAMURA, Wako-shi (JP)

(73) Assignee: Honda Motor Co., Ltd., Tokyo (JP)

(21) Appl. No.: 13/359,263

(22) Filed: Jan. 26, 2012

Related U.S. Application Data
(60) Provisional application No. 61/437,041, filed on Jan. 28, 2011.

(51) Int. Cl. H04R 29/00

(52) U.S. Cl. 381/56

(57) ABSTRACT

A sound source position estimation apparatus includes a signal input unit that receives sound signals of a plurality of channels; a time difference calculating unit that calculates a time difference between the sound signals of the channels, a state predicting unit that predicts present sound source state information from previous sound source state information which is sound source state information including a position of a sound source, and a state updating unit that estimates the sound source state information so as to reduce an error between the time difference calculated by the time difference calculating unit and the time difference based on the sound source state information predicted by the state predicting unit.

### CROSS REFERENCE TO RELATED APPLICATIONS

This application claims benefit from U.S. Provisional application Ser. No. 61/437,041, filed Jan. 28, 2011, the contents of which are entirely incorporated herein by reference.

### BACKGROUND OF THE INVENTION

1. Field of the Invention

The present invention relates to a sound source position estimation apparatus, a sound source position estimation method, and a sound source position estimation program.

2. Description of Related Art

Hitherto, sound source localization techniques of estimating a direction of a sound source have been proposed. The sound source localization techniques are useful for allowing a robot to understand surrounding environments or enhancing noise resistance. In the sound source localization techniques, an arrival time difference between sound waves of channels is detected using a microphone array including a plurality of microphones and a direction of a sound source is estimated based on the arrangement of the microphones. Accordingly, it is necessary to know the positions of the microphones or transfer functions between a sound source and the microphones and to synchronously record sound signals of channels.

Therefore, in the sound source localization technique described in N. Ono, H. Kohno, N. Ito, and S. Sagayama, BLIND ALIGNMENT OF ASYNCHRONOUSLY RECORDED SIGNALS FOR DISTRIBUTED MICROPHONE ARRAY, “2009 IEEE Workshop on Application of Signal Processing to Audio and Acoustics”, IEEE, Oct. 18, 2009, pp. 161-164, sound signals of channels from a sound source are asynchronously recorded using a plurality of microphones spatially distributed. In the sound source localization technique, the sound source position and the microphone positions are estimated using the recorded sound signals.

### SUMMARY OF THE INVENTION

However, in the sound source localization technique described in the above-mentioned document, it is not possible to estimate a position of a sound source in real time at the same time as a sound signal is input.

The invention is made in consideration of the above-mentioned problem and provides a sound source position estimation apparatus, a sound source position estimation method, and a sound source position estimating program, which can estimate a position of a sound source in real time at the same time as a sound signal is input.

(1) According to a first aspect of the invention, there is provided a sound source position estimation apparatus including: a signal input unit that receives sound signals of a plurality of channels; a time difference calculating unit that calculates a time difference between the sound signals of the channels; a state predicting unit that predicts present sound source state information from previous sound source state information which is sound source state information including a position of a sound source; and a state updating unit that estimates the sound source state information so as to reduce an error between the time difference calculated by the time difference calculating unit and the time difference based on the sound source state information predicted by the state predicting unit.

(2) A second aspect of the invention is the sound source position estimation apparatus according to the first aspect, wherein the state updating unit calculates a Kalman gain based on the error and multiplies the calculated Kalman gain by the error.

(3) A third aspect of the invention is the sound source position estimation apparatus according to the first or second aspect, wherein the sound source state information includes positions of sound pickup units supplying the sound signals to the signal input unit.

(4) A fourth aspect of the invention is the sound source position estimation apparatus according to the third aspect, further comprising a convergence determining unit that determines whether a variation in position of the sound source converges based on the variation in position of the sound pickup units.

(5) A fifth aspect of the invention is the e sound source position estimation apparatus according to the third aspect, further comprising a convergence determining unit that determines an estimated point at which an evaluation value, which is obtained by adding signals obtained by compensating for the sound signals of the plurality of channels with a phase from a predetermined estimated point of the position of the sound source to the positions of the sound pickup units corresponding to the plurality of channels, is maximized and that determines whether the variation in position of the sound source converges based on the distance between the determined estimated point and the position of the sound source indicated by the sound source state information estimated by the state updating unit.

(6) A sixth aspect of the invention is the sound source position estimation apparatus according to the fifth aspect, wherein the convergence determining unit determines the estimated point using a delay-and-sum beam-forming method and determines whether the variation in position f the sound source converges based on the distance between the determined estimated point and the position of the sound source indicated by the sound source state information estimated by the state updating unit.

(7) According to a seventh aspect of the invention, there is provided a sound source position estimation method including: receiving sound signals of a plurality of channels; calculating a time difference between the sound signals of the channels; predicting present sound source state information from previous sound source state information which is sound source state information including a position of a sound source; and estimating the sound source state information so as to reduce an error between the calculated time difference and the time difference based on the predicted sound source state information.

(8) According to an eighth aspect of the invention, there is provided a sound source position estimation program causing a computer of a sound source position estimation apparatus to perform the processes of: receiving sound signals of a plurality of channels; calculating a time difference between the sound signals of the channels; predicting present sound source state information from previous sound source state information which is sound source state information including a position of a sound source; and estimating the sound source state information so as to reduce an error between the calculated time difference and the time difference based on the predicted sound source state information.

According to the first, seventh, and eighth aspects of the invention, it is possible to estimate a position of a sound source in real time at the same time as a sound signal is input.

According to the second aspect of the invention, it is possible to stably estimate a position of a sound source so as to reduce the estimation error of the position of the sound source.

According to the third aspect of the invention, it is possible to estimate a position of a sound source and positions of microphones at the same time.

According to the fourth, fifth, and sixth aspects of the invention, it is possible to acquire a position of a sound source at which an error converges.

### BRIEF DESCRIPTION OF THE DRAWINGS

FIG. 1 is a diagram schematically illustrating the configuration of a sound source position estimation apparatus according to a first embodiment of the invention.

FIG. 2 is a plan view illustrating the arrangement of sound pickup units according to the first embodiment.

FIG. 3 is a diagram illustrating observation times of a sound source in the sound pickup units according to the first embodiment.

FIG. 4 is a conceptual diagram schematically illustrating prediction and update of sound source state information.

FIG. 5 is a conceptual diagram illustrating an example of the positional relationship between a sound source and the sound pickup units according to the first embodiment.

FIG. 6 is a conceptual diagram illustrating an example of a rectangular movement model.

FIG. 7 is a conceptual diagram illustrating an example of a circular movement model.

FIG. 8 is a flowchart illustrating a sound source position estimation process according to the first embodiment.

FIG. 9 is a diagram schematically illustrating the configuration of a sound source position estimation apparatus according to a second embodiment of the invention.

FIG. 10 is a diagram schematically illustrating the configuration of a convergence determining unit according to the second embodiment.

FIG. 11 is a flowchart illustrating a convergence determining process according to the second embodiment.

FIG. 12 is a diagram illustrating examples of a temporal variation in estimation error.

FIG. 13 is a diagram illustrating other examples of a temporal variation in estimation error.

FIG. 14 is a table illustrating examples of an observation time error.

FIG. 15 is a diagram illustrating an example of a situation of sound source localization.

FIG. 16 is a diagram illustrating another example of the situation of sound source localization.

FIG. 17 is a diagram illustrating still another example of the situation of sound source localization.

FIG. 18 is a diagram illustrating an example of a convergence time.

FIG. 19 is a diagram illustrating an example of an error of an estimated sound source position.

### DETAILED DESCRIPTION OF THE INVENTION

### First Embodiment

Hereinafter, a first embodiment of the invention will be described with reference to the accompanying drawings.

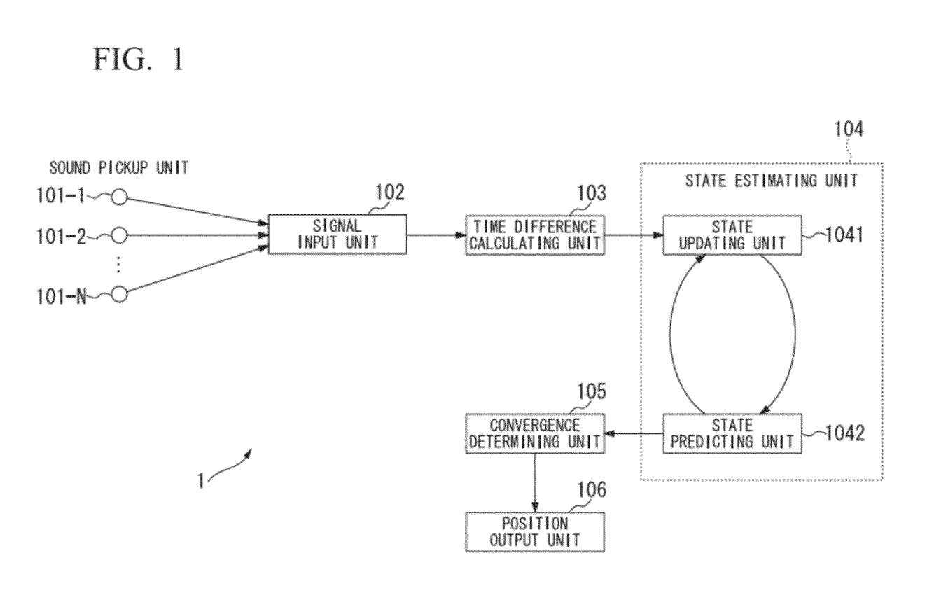

FIG. 1 is a diagram schematically illustrating the configuration of a sound source position estimation apparatus 1 according to the first embodiment of the invention.

The sound source position estimation apparatus 1 includes N (where N is an integer larger than 1) sound pickup units 101-1 to 101-N, a signal input unit 102, a time difference calculating unit 103, a state estimating unit 104, a convergence determining unit 105, and a position output unit 106.

The state estimating unit 104 includes a state updating unit 1041 and a state predicting unit 1042.

The sound pickup units 101-1 to 101-N each includes an electro-acoustic converter converting a sound wave which is air vibration into an analog sound signal which is an electrical signal. The sound pickup units 101-1 to 101-N each output the converted analog sound signal to the signal input unit 102.

For example, the sound pickup units 101-1 to 101-N may be distributed outside the case of the sound source position estimation apparatus 1. In this case, the sound pickup units 101-1 to 101-N each output a generated one-channel sound signal to the signal input unit 102 by wire or wirelessly. The sound pickup units 101-1 to 101-N each are, for example, a microphone unit.

An arrangement example of the sound pickup units 101-1 to 101-N will be described below.

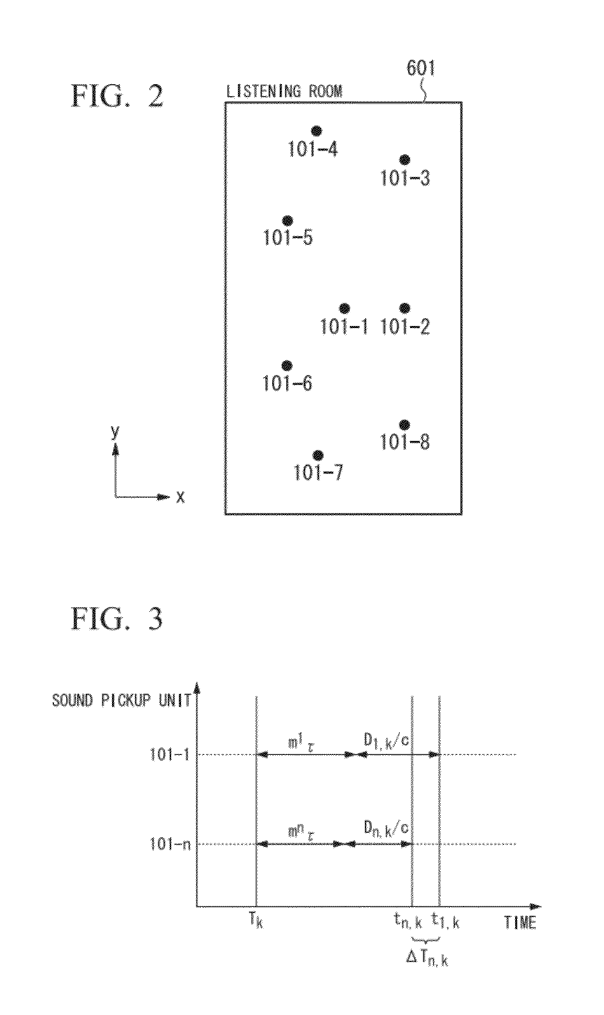

FIG. 2 is a plan view illustrating an arrangement example of the sound pickup units 101-1 to 101-8 according to this embodiment.

In FIG. 2, the horizontal axis represents the x axis and the vertical axis represents the y axis.

The vertically-long rectangle shown in FIG. 2 represents a horizontal plane of a listening room 601 of which the coordinates in the height direction (the z axis direction) are constant. In FIG. 2, black circles represent the positions of the sound pickup units 101-1 to 101-8.

The sound pickup unit 101-1 is disposed at the center of the listening room 601. The sound pickup unit 101-2 is disposed at a position separated in the positive x axis direction from the center of the listening room 601. The sound pickup unit 101-3 is disposed at a position separated in the positive y axis direction from the sound pickup unit 101-2. The sound pickup unit 101-4 is disposed at a position separated in the negative (−) x axis direction and the positive (+) y axis direction from the sound pickup unit 101-3. The sound pickup unit 101-5 is disposed at a position separated in the negative (−) x axis direction and the negative (−) y axis direction from the sound pickup unit 101-4. The sound pickup unit 101-6 is disposed at a position separated in the negative (−) y axis direction from the sound pickup unit 101-5. The sound pickup unit 101-7 is disposed at a position separated in the positive (+) x axis direction and the negative (−) y axis direction from the sound pickup unit 101-6. The sound pickup unit 101-8 is disposed at a position separated in the positive (+) x axis direction and the positive (+) y axis direction from the sound pickup unit 101-7 and separated in the positive (+) y axis direction from the sound pickup unit 101-2. In this manner, the sound pickup units 101-2 to 101-8 are arranged counterclockwise in the xy plane about the sound pickup unit 101-1.

Referring to FIG. 1 again, the analog sound signals from the sound pickup units 101-1 to 101-N are input to the signal input unit 102. In the following description, the channels corresponding to the sound pickup units 101-1 to 101-N are referred to as Channels 1 to N, respectively. The signal input unit 102 converts the analog sound signals of the channels in the analog-to-digital (A/D) conversion manner to generate digital sound signals.

The signal input unit 102 outputs the digital sound signals of the channels to the time difference calculating unit 103.

The time difference calculating unit 103 calculates the time difference between the channels for the sound signals input from the signal input unit 102. The time difference calculating unit 103 calculates, for example, the time difference t_{n,k}−t_{1,k} (hereinafter, referred to as Δt_{n,k}) between the sound signal of Channel 1 and the sound signal of Channel n (where n is an integer greater than 1 and equal to or smaller than N). Here, k is an integer indicating a discrete time. When calculating the time difference Δt_{n,k}, the time difference calculating unit 103 gives a time difference, for example, between the sound signal of Channel 1 and the sound signal of Channel n, calculates a mutual correlation therebetween, and selects the time difference in which the calculated mutual correlation is maximized.

The time difference Δt_{n,k} will be described below with reference to FIG. 3.

FIG. 3 is a diagram illustrating observation times t_{1,k} and t_{n,k} at which the sound pickup units 101-1 and 101-n observes a sound source.

In FIG. 3, the horizontal axis represents a time t and the vertical axis represents the sound pickup unit. In FIG. 3, Tₖ represents the time (sound-producing time) at which a sound source produces a sound wave. In addition, t_{1,k} represents the time (observation time) at which a sound wave received from a sound source is observed by the sound pickup unit 101-1. Similarly, t_{n,k} represents the observation time at which a sound wave received from the sound source is observed by the sound pickup unit 101-n. The observation time t_{1,k} is a time obtained by adding an observation time error m¹_{τ} in Channel 1 at the sound-producing time Tₖ to a propagation time D_{1,k}/c of the sound wave from the sound source to the sound pickup unit 101-1. The observation time error m¹_{τ} is the difference between the time at which the sound signal of Channel 1 is observed and the absolute time. The reason of the observation time error is a measuring error of the position of the sound pickup unit 101-n and the position of a sound source or a measuring error of the arrival time at which the sound wave arrives at the sound pickup unit 101-n. D_{1,k} represents the distance from the sound source to the sound pickup unit 101-n and c represents a sound speed. The observation time t_{n,k} is the time obtained by adding the observation time error mⁿ_{τ} in Channel n at the sound-producing time Tₖ to the propagation time D_{1,k}/c of the sound wave from the sound source to the sound pickup unit 101-n. Therefore, the time difference Δt_{n,k} (=t_{n,k}−t_{1,k}) is expressed by Equation 1.

$${t}_{n , k} - {t}_{1 , k} = \frac{{D}_{n , k} - {D}_{1 , k}}{c} + {m}_{τ}^{n} - {m}_{τ}^{1} \qquad ( 1 )$$

The distance D_{n,k} from the sound source to the sound pickup unit 101-n is expressed by Equation 2.

D_{n,k}=\sqrt{(xₖ−mₓⁿ)²+(yₖ−m_{y}ⁿ)²} (2)

In Equation 2, (xₖ, yₖ) represents the position of the sound source at time k. (mⁿₓ, mⁿ_{y}) represents the position of the sound pickup unit 101-n.

Here, a vector [Δt_{2,k}, . . . , Δt_{n,k}, . . . , Δt_{N,k}]^{T} of (N-1) columns having the time differences Δt_{n,k} of the channels n is referred to as an observed value vector ζₖ. Here, T represents the transpose of a matrix or a vector. The time difference calculating unit 103 outputs time difference information indicating the observed value vector ζₖ to the state estimating unit 104.

Referring to FIG. 1 again, the state estimating unit 104 predicts present (at time k) sound source state information from previous (for example, at time k−1) sound source state information and estimates sound source state information based on the time difference indicated by the time different information input from the time difference calculating unit 103. The sound source state information includes, for example, information indicating the position (xₖ, yₖ) of a sound source, the positions (mⁿₓ, mⁿ_{y}) of the sound pickup units 101-n, and the observation time error mⁿ_{τ}. When estimating the sound source state information, the state estimating unit 104 updates the sound source state information so as to reduce the error between the time difference indicated by the time difference information input from the time difference calculating unit 103 and the time difference based on the predicted sound source state information. The state estimating unit 104 uses, for example, an extended Kalman filter (EKF) method to predict and update the sound source state information. The prediction and updating using the EKF method will be described later. The state estimating unit 104 may use a minimum mean squared error (MMSE) method or other methods instead of the extended Kalman filter method.

The state estimating unit 104 outputs the estimated sound source state information to the convergence determining unit 105.

The convergence determining unit 105 determines whether the variation in position of the sound source indicated by the sound source state information ηₖ′ input from the state estimating unit 104 converges. The convergence determining unit 105 outputs sound source convergence information indicating that the estimated position of the sound source converges to the position output unit 106. Here, sign ′ represents that the corresponding value is an estimated value.

The convergence determining unit 105 calculates, for example, the average distance Δηₘ′ between the previous estimated position (mⁿ_{x,k-1}′, mⁿ_{y,k-1}′) of the sound pickup unit 101-n and the present estimated position (mⁿ_{x,k}′, mⁿ_{y,k}′) of the sound pickup unit 101-n. The convergence determining unit 105 determines that the position of the sound source converges when the average distance Δηₘ′ is smaller than a predetermined threshold value. In this manner, the estimated position of a sound source is not directly used to determine the convergence, because the position of a sound source is not known and varies with the lapse of time. On the contrary, the estimated position (mⁿ_{x,k}′, mⁿ_{y,k}′) of the sound pickup unit 101-n is used to determine the convergence, because the position of the sound pickup unit 101-n is fixed and the sound source state information depends on the estimated position of the sound pickup unit 101-n in addition to the estimated position of a sound source.

The position output unit 106 outputs the sound source position information included in the sound source state information input from the convergence determining unit 105 to the outside when the sound source convergence information is input from the convergence determining unit 105.

The prediction and updating of the sound source state information using the EKF method will be described below in brief.

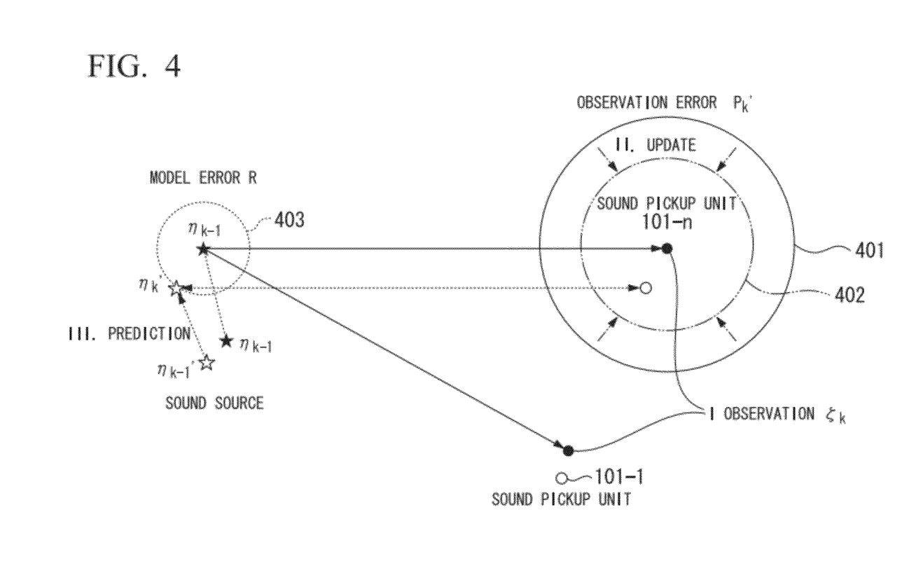

FIG. 4 is a conceptual diagram illustrating the prediction and updating of the sound source state information in brief.

In FIG. 4, black stars represent true values of the position of a sound source. White stars represent estimated values of the position of the sound source. Black circles represent true values of the positions of the sound pickup units 101-1 and 101-n. White circles represent estimated values of the positions of the sound pickup units 101-1 and 101-n. The solid circle 401 centered on the position of the sound pickup unit 101-n represents the magnitude of the observation error of the position of the sound pickup unit 101-n. The one-dot chained circle 402 centered on the position of the sound pickup unit 101-n represents the magnitude of the observation error of the position of the sound pickup unit 101-n after being subjected to an update step to be described later. That is, the circles 401 and 402 represent that the sound source state information including the position of the sound pickup unit 101-n is updated in the update step so as to reduce the observation error. The observation error is quantitatively expressed by a variance-covariance matrix Pₖ′ to be described later. The dotted circle 403 centered on the position of a sound source is a circle representing a model error R between the actual position of the sound source and the estimated position of the sound source using a movement model of the sound source. The model error is quantitatively expressed by a variance-covariance matrix R.

The EKF method includes I. observation step, II. update step, and III. prediction step. The state estimating unit 104 repeatedly performs these steps.

In the I. observation step, the state estimating unit 104 receives the time difference information from the time difference calculating unit 103. The state estimating unit 104 receives as an observed value the time difference information ζk indicating the time difference ΔT,_{n,k} between the sound pickup units 101-1 and 101-n with respect to a sound signal from a sound source.

In the II. updating step, the state estimating unit 104 updates the variance-covariance matrix Pₖ′ indicating the error of the sound source state information and the sound source state information ηₖ′ so as to reduce the observation error between the observed value vector ζk and the observed value vector ζₖ′ based on the sound source state information ηₖ′.

In the III. prediction step, the state predicting unit 1042 predicts the sound source state information η_{k|k-1}′ at the present time k from the sound source state information ηₖ₋₁′ at the previous time k−1 based on the movement model expressing the temporal variation of the true position of a sound source. The state predicting unit 1042 updates the variance-covariance matrix Pₖ₋₁′ based on the variance-covariance matrix P_{K-1}′ at the previous time k−1 and the variance-covariance matrix R representing the model error between the movement model of the position of a sound source and the estimated position.

Here, the sound source state information ηₖ′ includes the estimated position (xₖ′, yₖ′) of the sound source, the estimated positions (m₁_{x,k}′, m¹_{y,k}′) to (m^{N}_{x,k}′, m^{N}_{y,k}′) of the sound pickup units 101-1 to 101-N, and the estimated values m¹_{τ}′ to m^{N}_{τ}′ of the observation time error as elements. That is, the sound source state information ηₖ′ is information expressed, for example, by a vector [xₖ′, yₖ′, m¹_{x,k}′, m¹_{y,k}′, m¹_{τ}′, . . . , m^{N}_{x,k}′, m^{N}_{y,k}′, m^{N}_{τ}′]^{T}. In this manner, by using the EKF method, the unknown position of the sound source, the positions of the sound pickup units 101-1 to 101-N, and the observation time error are estimated to slowly reduce the prediction error.

Referring to FIG. 1 again, the configuration of the state estimating unit 104 will be described below.

The state estimating unit 104 includes the state updating unit 1041 and the state predicting unit 1042.

The state updating unit 1041 receives time difference information indicating the observed value vector ζₖ from the time difference calculating unit 103 (I. observation step). The state updating unit 1041 receives the sound source state information η_{k|k-1}′ and the covariance matrix P_{k|k-1} from the state predicting unit 1042. The sound source state information η_{k|k-1}′ is sound source state information at the present time k predicted from the sound source state information ηₖ₋₁′ at the previous time k−1. The elements of the covariance matrix P_{k|k-1} are covariance of the elements of the vector indicated by the sound source state information η_{k|k-1}′. That is, the covariance matrix P_{k|k-1} indicates the error of the sound source state information η_{k|k-1}′. Thereafter, the state updating unit 1041 updates the sound source state information η_{k|k-1}′ to the sound source state information ηₖ′ at the time k and updates the covariance matrix P_{k|k-1} to the covariance matrix Pₖ (II. updating step). The state updating unit 1041 outputs the updated sound source state information ηₖ′ and covariance matrix Pₖ at the present time k to the state predicting unit 1042.

The updating process of the updating step will be described below in detail.

The state updating unit 1041 adds the observation error vector δₖ to the observed value vector ζₖ and updates the observed value vector ζₖ to the addition result. The observation error vector δₖ is a random vector having an average value of 0 and following the Gaussian distribution distributed with predetermined covariance. A matrix including this covariance as elements of the rows and columns is expressed by a covariance matrix Q.

The state updating unit 1041 calculates a Kalman gain Kₖ, for example, using Equation 3 based on the sound source state information η_{k|k-1}′, the covariance matrix P_{k|k-1}, and the covariance matrix Q.

Kₖ=P_{k|k-1}Hₖ^{T}(HₖP_{k|k-1}hₖ^{T}+Q)⁻¹ (3)

In Equation 3, the matrix Hₖ is a Jacobian obtained by partially differentiating the elements of an observation function vector h(η_{k|k-1}′) with respect to the elements of the sound source state information η_{k|k-1}′, as expressed by Equation 4.

$${H}_{k} = \frac{\partial h ( {η}_{k}^{′} )}{\partial {η}_{k}^{′}} {\vert}_{{η}_{k \vert k - 1}^{′}} \qquad ( 4 )$$

The observation function vector h(ηₖ′) is expressed by Equation 5.

$$h ( {η}_{k}^{′} ) = [ \begin{matrix}\frac{{D}_{2 , k}^{′} - {D}_{1 , k}^{′}}{c} + {m}_{τ}^{2 ′} - {m}_{τ}^{1 ′} \\ ⋮ \\ \frac{{D}_{N , k}^{′} - {D}_{1 , k}^{′}}{c} + {m}_{τ}^{N′} - {m}_{τ}^{1 ′}\end{matrix} ] \qquad ( 5 )$$

The observation function vector h(ηₖ′) is an observed value vector ζₖ′ based on the sound source state information ηₖ′. Therefore, the state updating unit 1041 calculates the observed value vector ζ_{k|k-1}′ for the sound source state information η_{k|k-1}′ at the present time k predicted from the sound source state information ηₖ₋₁′ at the previous time k−1, for example, using Equation 5.

The state updating unit 1041 calculates the sound source state information ηₖ′ at the present time k based on the observed value vector ζₖ at the present time k, the calculated observed value vector ζ_{k|k-1}′, and the calculated Kalman gain Kₖ, for example, using Equation 6.

ηₖ′=η_{k|k-1}′+Kₖ(ζₖ−ζ_{k|k-1}′) (6)

That is, Equation 6 means that a residual error value is added to the observed value vector ζ_{k|k-1}′ at the present time k estimated from the observed value vector ζₖ′ at the previous time k−1 to calculate the sound source state information ηₖ′. The residual error value to be added is a vector value obtained by multiplying the difference between the observed value vector ζₖ′ at the present time k and the observed value vector ζ_{k|k-1}′ by the Kalman gain Kₖ.

The state updating unit 1041 calculates the covariance matrix Pₖ based on the Kalman gain Kₖ, the matrix Hₖ, and the covariance matrix P_{k|k-1}′ at the present time k predicted from the covariance matrix Pₖ₋₁ at the previous time k−1, for example, using Equation 7.

Pₖ=(I−KₖHₖ)P_{k|k-1} (7)

In Equation 7, I represents a unit matrix. That is, Equation 7 means that the matrix obtained by subtracting the Kalman gain Kₖ and the matrix Hₖ from the unit matrix I is multiplied to reduce the magnitude of the error of the sound source state information ηₖ′.

The state predicting unit 1042 receives the sound source state information ηₖ′ and the covariance matrix Pₖ from the state updating unit 1041. The state predicting unit 1042 predicts the sound source state information η_{k|k-1}′ at the present time k from the sound source state information ηₖ₋₁′ at the previous time k−1 and predicts the covariance matrix P_{k|k-1} from the covariance matrix Pₖ₋₁′ (III. Prediction step).

The prediction process in the prediction step will be described below in more detail.

In this embodiment, for example, a movement model in which the sound source position (xₖ₋₁′, yₖ₋₁′) at the previous time k−1 is displaced by a displacement (Δx, Δy)^{T} until the present time k is assumed.

The state predicting unit 1042 adds an error vector εₖ representing an error thereof to the displacement (Δx, Δy)^{T} and updates the displacement (Δx, Δy)^{T} to the sum as the addition result. The error vector εₖ is a random vector having an average value of 0 and following the Gaussian distribution. A matrix having the covariance representing the characteristics of the Gaussian distribution as elements of the rows and columns is represented by a covariance matrix R.

The state predicting unit 1042 predicts the sound source state information η_{k|k-1}′ at the present time k from the sound source state information ηₖ₋₁′ at the previous time k−1, for example, using Equation 8.

$${η}_{k \vert k - 1}^{′} = {η}_{k - 1}^{′} + {F}_{η}^{T} [ \begin{matrix}Δ x \\ Δ y\end{matrix} ] \qquad ( 8 )$$

In Equation 8, the matrix F_{η} is a matrix of 2 rows and (2+3N) columns expressed by Equation 9.

$${F}_{η} = [ \begin{matrix}1 & 0 & 0 & 0 & … & 0 \\ 0 & 1 & 0 & 0 & … & 0\end{matrix} ] \qquad ( 9 )$$

Then, the state predicting unit 1042 predicts the covariance matrix P_{k|k-1} at the present time k from the covariance matrix Pₖ₋₁ at the previous time k−1, for example, using Equation 10.

P_{k|k-1}=Pₖ₋₁+F_{η}^{T}RF_{η}^{T} (10)

That is, Equation 10 means that the error of the sound source state information ηₖ₋₁′ expressed by the covariance matrix Pₖ₋₁ at the previous time k−1 to the covariance matrix R representing the error of the displacement to calculate the covariance matrix Pₖ at the present time k.

The state predicting unit 1042 outputs the sound source state information η_{k|k-1}′ and the covariance matrix P_{k|k-1}′ at the calculation time k to the state updating unit 1041. The state predicting unit 1042 outputs the sound source state information η_{k|k-1}′ at the calculation time k to the convergence determining unit 105.

It has been hitherto that the state estimating unit 104 performs I. observation step, II. updating step, and III. Prediction step every time k, this embodiment is not limited to this configuration. In this embodiment, the state estimating unit 104 may perform I. observation step and II. updating step every time k and may perform III. prediction step every time l. The time l is a discrete time counted with a time interval different from the time k. For example, the time interval from the previous time l−1 to the present time l may be larger than the time interval from the previous time k−1 to the present time k. Accordingly, even when the time of the operation of the state estimating unit 104 is different from the time of operation of the time difference calculating unit 103, it is possible to synchronize both processes.

Therefore, the state updating unit 1041 receives the sound source state information η_{l|l-1}′ at the time l when the state predicting unit 1042 outputs as the sound source state information η_{k|k-1}′ at the corresponding time k. The state updating unit 1041 receives the covariance matrix P_{l|l-1} output from the state predicting unit 1042 as the covariance matrix P_{k|k-1}′. The state predicting unit 1042 receives the sound source state information ηₖ′ output from the state updating unit 1041 as the sound source state information ηₗ₋₁′ at the corresponding previous time l−1. The state predicting unit 1042 receives the covariance matrix Pₖ output from the state updating unit 1041 as the covariance matrix P_{I-1}.

The positional relationship between the sound source and the sound pickup unit 101-n will be described below.

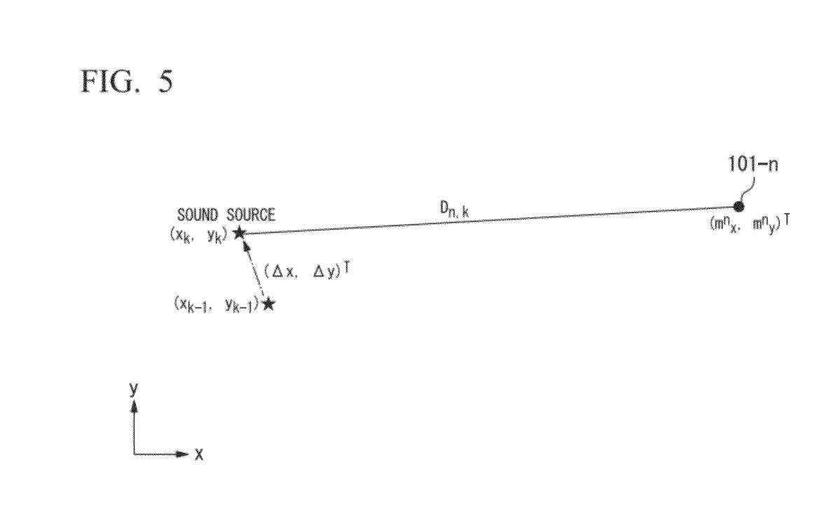

FIG. 5 is a conceptual diagram illustrating an example of the positional relationship between the sound source and the sound pickup unit 101-n.

In FIG. 5, the black stars represent the sound source position (xₖ₋₁, yₖ₋₁) at the previous time k−1 and the sound source position (xₖ, yₖ) at the present time k. The one-dot chained arrow having the sound source position (xₖ₋₁, yₖ₋₁) as a start point and the sound source position (xₖ, yₖ) as an end point represents the displacement (Δx, Δy)^{T}.

The black circle represents the position (mⁿₓ, mⁿ_{y})^{T} of the sound pickup unit 101-n. The solid line D_{n,k} having the sound source position (xₖ, yₖ)^{T} as a start point and having the position (mⁿₓ, mⁿ_{y})^{T} of the sound pickup unit 101-n as an end point represents the distance therebetween. In this embodiment, the true position of the sound pickup unit 101-n is assumed as a constant, but the predicted value of the position of the sound pickup unit 101-n includes an error. Accordingly, the predicted value of the sound pickup unit 101-n is a variable. The index of the error of the distance D_{n,k} is the covariance matrix Pₖ.

A rectangular movement model will be described below as an example of the movement model of a sound source.

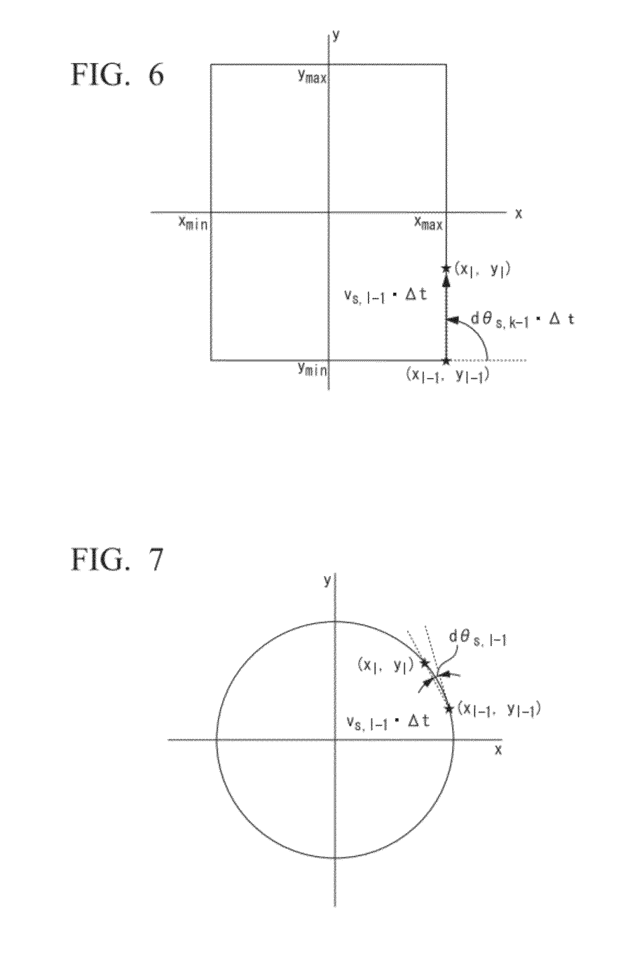

FIG. 6 is a conceptual diagram illustrating an example of the rectangular movement model.

The rectangular movement model is a movement model in which a sound source moves in a rectangular track. In FIG. 6, the horizontal axis represents an x axis and the vertical axis represents a y axis. The rectangle shown in FIG. 6 represents the track in which a sound source moves. The maximum value in x coordinate of the rectangle is xₘₐₓ and the minimum value is xₘᵢₙ. The maximum value in y coordinate is yₘₐₓ and the minimum value is yₘᵢₙ. The sound source straightly moves in one side of the rectangle and the movement direction thereof is changed by 90° when the sound source reaches a vertex of the rectangle, that is, the x coordinate of the sound source reaches xₘₐₓ or xₘᵢₙ and the y coordinate thereof reaches yₘₐₓ or yₘᵢₙ.

That is, in the rectangular movement model, the movement direction Θ_{s,l-1} of the sound source is any one of 0°, 90°, 180°, and −90° about the positive x axis direction. When the sound source moves in the side, the variation dθ_{s,l-l}Δt in the movement direction is 0°. Here, dθ_{s,l-1} represents the angular velocity of the sound source and Δt represents the time interval from the previous time l−1 to the present time l. When the sound source reaches a vertex, the variation dθ_{s,l-1}Δt in the movement direction is 90° or −90° with the counterclockwise rotation as positive.

In this embodiment, when the rectangular movement model is used, the sound source position information may be expressed by a three-dimensional vector η_{s,1} having the two-dimensional orthogonal coordinates (x₁, y₁) and the movement direction θ as elements. The sound source position information η_{s,1} is information included in the sound source state information η₁. In this case, the state predicting unit 1042 may predict the sound source position information using Equation 11 instead of Equation 8.

$${η}_{s , l \vert l - 1}^{′} = {η}_{s , l - 1}^{′} + [ \begin{matrix}sin {θ}_{s , l - 1} & 0 \\ cos {θ}_{s , l - 1} & 0 \\ 0 & 1\end{matrix} ] [ \begin{matrix}{v}_{s , l - 1} Δ t \\ d {θ}_{s , l - 1} Δ t\end{matrix} ] + δη \qquad ( 11 )$$

In Equation 11, δη represents an error vector of the displacement. The error vector δη is a random vector having an average value of 0 and following a Gaussian distribution distributed with a predetermined covariance. A matrix having the covariance as elements of the rows and columns is expressed by a covariance matrix R.

The state predicting unit 1042 predicts the covariance matrix P_{l|l-1} at the present time l, for example, using Equation 12 instead of Equation 10.

P_{l|l-1}=G₁Pₗ₋₁G₁^{T}+F^{T}RF (12)

In Equation 12, the matrix G₁ is a matrix expressed by Equation 13.

$${G}_{l} = \frac{\partial {η}_{s , l \vert l - 1}^{′}}{\partial {η}_{s , l - 1}^{′}} = I = {F}^{T} [ \begin{matrix}0 & 0 & - {v}_{s , l - 1} sin {θ}_{s , l - 1} \\ 0 & 0 & {v}_{x , l - 1} cos {θ}_{s , l - 1} \\ 0 & 0 & 0\end{matrix} ] F \qquad ( 13 )$$

In Equation 13, the matrix F is a matrix expressed by Equation 14.

F_{η}=[I^{3×3} O^{3×3}] (14)

In Equation 14, I^{3×3} is a unit matrix of 3 rows and 3 columns and O^{3×3} is a zero matrix of 3 rows and 3N columns.

A circular movement model will be described below as an example of the movement model of a sound source.

FIG. 7 is a conceptual diagram illustrating an example of the circular movement model.

The circular movement model is a movement model in which a sound source moves in a circular track. In FIG. 7, the horizontal axis represents an x axis and the vertical axis represents the y axis. The circle shown in FIG. 7 represents the track in which a sound source circularly moves. In the circular movement model, the variation dθ_{s,l-1}Δt in the movement direction is a constant value Δθ and the direction of the sound source also varies depending thereon.

When the circular movement model is used, the sound source position information may be expressed by a three-dimensional vector ηs,l having the two-dimensional orthogonal coordinates (x₁, y₁) and the movement direction θ as elements. In this case, the state predicting unit 1042 predicts the sound source position information using Equation 15 instead of Equation 8.

$${η}_{s , l \vert l - 1}^{′} = [ \begin{matrix}cos Δθ & - sin Δθ & 0 \\ sin Δθ & cos Δθ & 0 \\ 0 & 0 & 1\end{matrix} ] {η}_{s , l - 1}^{′} + [ \begin{matrix}0 \\ 0 \\ Δθ\end{matrix} ] + δη \qquad ( 15 )$$

The state predicting unit 1042 predicts the covariance matrix Pₗₗ₋₁ at the present time l using Equation 12. Here, the matrix G₁ expressed by Equation 16 is used instead of the matrix G₁ expressed by Equation 13 as the matrix G₁.

$${G}_{l} = \frac{\partial {η}_{s , l \vert l - 1}^{′}}{\partial {η}_{s , l - 1}^{′}} = I + {F}^{T} [ \begin{matrix}cos Δθ & - sin Δθ & 0 \\ sin Δθ & cos Δθ & 0 \\ 0 & 0 & 0\end{matrix} ] F \qquad ( 16 )$$

A sound source position estimating process according to this embodiment will be described below.

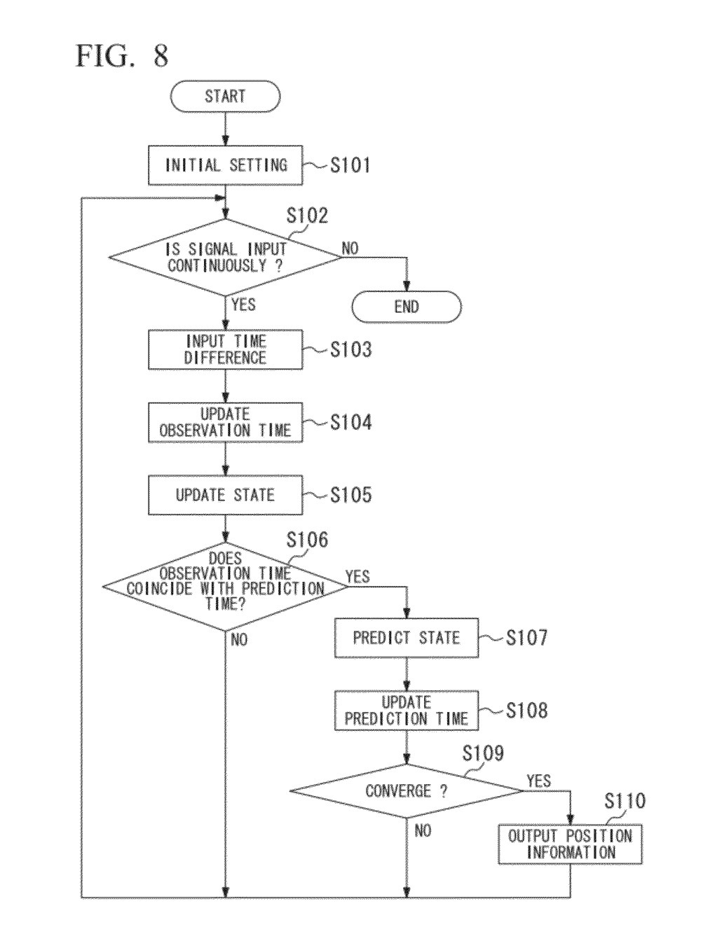

FIG. 8 is a flowchart illustrating the of a sound source position estimating process according to this embodiment.

(Step S101) The sound source position estimation apparatus 1 sets initial values of variables to be treated. For example, the state estimating unit 104 sets the observation time k and the prediction time l to 0 and sets the sound source state information η_{k|k-1} and the covariance matrix P_{k|k-1} to predetermined values. Thereafter, the flow of processes goes to step S102.

(Step S102) The signal input unit 102 receives a sound signal for each channel from the sound pickup units 101-1 to 101-N. The signal input unit 102 determines whether the sound signal is continuously input. When it is determined that the sound signal is continuously input (Yes in step S102), the signal input unit 102 converts the input sound signal in the A/D conversion manner and outputs the resultant sound signal to the time difference calculating unit 103, and then the flow of processes goes to step S103. When it is determined that the sound signal is not continuously input (No in step S102), the flow of processes is ended.

(Step S103) The time difference calculating unit 103 calculates the inter-channel time difference between the sound signals input from the signal input unit 102. The time difference calculating unit 103 outputs time difference information indicating the observed value vector ζₖ having the calculated inter-channel time difference as elements to the state updating unit 1041. Thereafter, the flow of processes goes to step S104.

(Step S104) The state updating unit 1041 increases the observation time k by 1 every predetermined time to update the observation time k. Thereafter, the flow of processes goes to step S105.

(Step S105) The state updating unit 1041 adds the observation error vector δₖ to the observed value vector ζₖ indicated by the time difference information input from the time difference calculating unit 103 to updates the observed value vector ζₖ.

The state updating unit 1041 calculates the Kalman gain Kₖ based on the sound source state information η_{k|k-1}′, the covariance matrix P_{k|k-1}, and the covariance matrix Q, for example, using Equation 3.

The state updating unit 1041 calculates the observed value vector η_{k|k-1}′ with respect to the sound source state information η_{k|k-1}′ at the present observation time k, for example, using Equation 5.

The state updating unit 1041 calculates the sound source state information ηₖ′ at the present observation time k based on the observed value vector ζₖ at the present observation time k, the calculated observed value vector ζ_{k|k-1}′, and the calculated Kalman gain Kₖ, for example, using Equation 6.

The state updating unit 1041 calculates the covariance matrix Pₖ at the present observation time k based on the Kalman gain Kₖ, the matrix Hₖ, and the covariance matrix P_{k|k-1}, for example, using Equation 7. Thereafter, the flow of processes goes to step S106.

(Step S106) The state updating unit 1041 determines whether the present observation time corresponds to the prediction time l when the prediction process is performed. For example, when the prediction step is performed once every N times (where N is an integer 1 or more, for example, 5) of the observation and updating steps, it is determined whether the remainder when dividing the observation time by N is 0. When it is determined that the present observation time k corresponds to the prediction time l (Yes in step S107), the flow of processes goes to step S107. When it is determined that the present observation time k does not correspond to the prediction time l (No in step S107), the flow of processes goes to step S102.

(Step S107) The state predicting unit 1042 receives the calculated sound source state information ηₖ′ and the covariance matrix Pₖ at the present observation time k output from the state updating unit 1041 as the sound source state information ηₗ₋₁′ and the covariance matrix Pₗ₋₁ at the previous prediction time l−1.

The state predicting unit 1042 calculates the sound source state information η_{l|l-1}′ at the present prediction time l from the sound source state information ηₗ₋₁′ at the previous prediction time l−1, for example, using Equation 8, 11, or 15. The state predicting unit 1042 calculates the covariance matrix P_{l|l-1} at the present prediction time l from the covariance matrix Pₗ₋₁ at the previous prediction time l−1, for example, using Equation 10 or 12.

The state predicting unit 1042 outputs the sound source state information η_{l|l-1}′ and the covariance matrix P_{l|l-1} at the present prediction time l to the state updating unit 1041. The state predicting unit 1042 outputs the calculated sound source state information η_{l|l-1}′ at the present prediction time l to the convergence determining unit 105. Thereafter, the flow of processes goes to step S108.

(Step S108) The state updating unit 1041 updates the prediction time by adding 1 to the present prediction time l. The state updating unit 1041 receives the sound source state information η_{l|l-1}′ and the covariance matrix P_{l|l-1} at the prediction time l output from the state predicting unit 1042 as the sound source state information η_{k|k-1}′ and the covariance matrix P_{k|k-1} at the present observation time k. Thereafter, the flow of processes goes to step S109.

(Step S109) the convergence determining unit 105 determines whether the variation of the sound source position indicated by the sound source state information ηₗ′ input from the state estimating unit 104 converges. The convergence determining unit 105 determines that the variation converges, for example, when the average distance Δηₘ′ between the previous estimated position of the sound pickup unit 101-n and the present estimated position of the sound pickup unit 101-n is smaller than a predetermined threshold value. When it is determined that the variation of the sound source position converges (Yes in step S109), the convergence determining unit 105 outputs the input sound source state information ηₗ′ to the position output unit 106. Thereafter, the flow of processes goes to step S110. When it is determined that the variation of the sound source position does not converge (No in step S109), the flow of processes goes to step S102.

(Step S110) The position output unit 106 outputs the sound source position information included in the sound source state information ηₗ′ input from the convergence determining unit 105 to the outside. Thereafter, the flow of processes goes to step S102.

In this manner, in this embodiment, sound signals of a plurality of channels are input, the inter-channel time difference between the sound signals is calculated, and the present sound source state information is predicted from the sound source state information including the previous sound source position. In this embodiment, the sound source state information is updated so as to reduce the error between the calculated time difference and the time difference based on the predicted sound source state information. Accordingly, it is possible to estimate the sound source position at the same time as the sound signal is input.

### Second Embodiment

Hereinafter, a second embodiment of the invention will be described with reference to the accompanying drawings. The same elements or processes as in the first embodiment are referenced by the same reference signs.

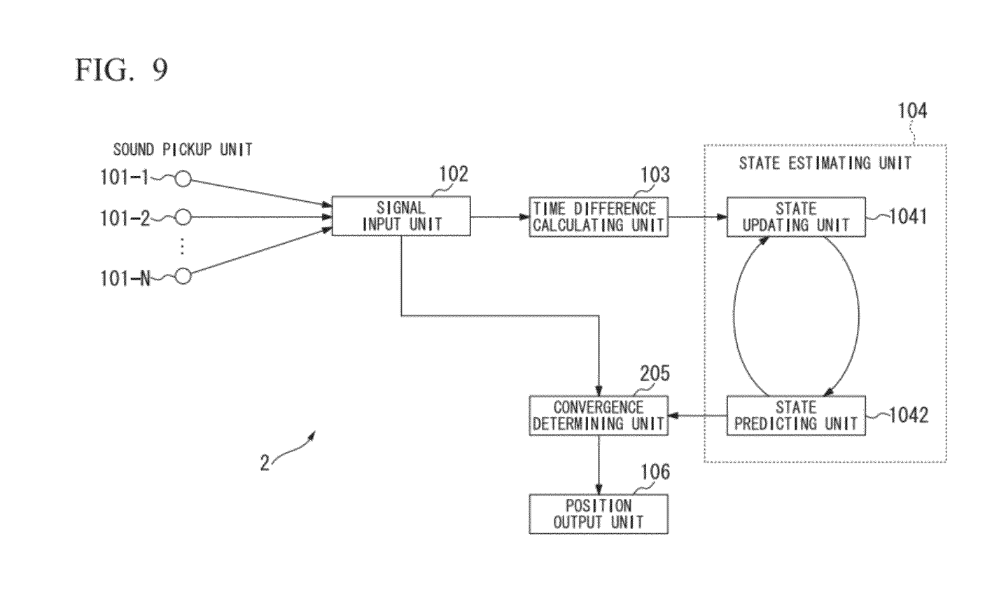

FIG. 9 is a diagram schematically illustrating the configuration of a sound source position estimation apparatus 2 according to this embodiment.

The sound source position estimation apparatus 2 includes N sound pickup units 101-1 to 101-N, a signal input unit 102, a time difference calculating unit 103, a state estimating unit 104, a convergence determining unit 205, and a position output unit 106. That is, the sound source position estimation apparatus 2 is different from the sound source position estimation apparatus 1 (see FIG. 1), in that it includes the convergence determining unit 205 instead of the convergence determining unit 105 and the signal input unit 102 also outputs the input sound signals to the convergence determining unit 205. The other elements are the same as in the sound source position estimation apparatus 1.

The configuration of the convergence determining unit 205 will be described below.

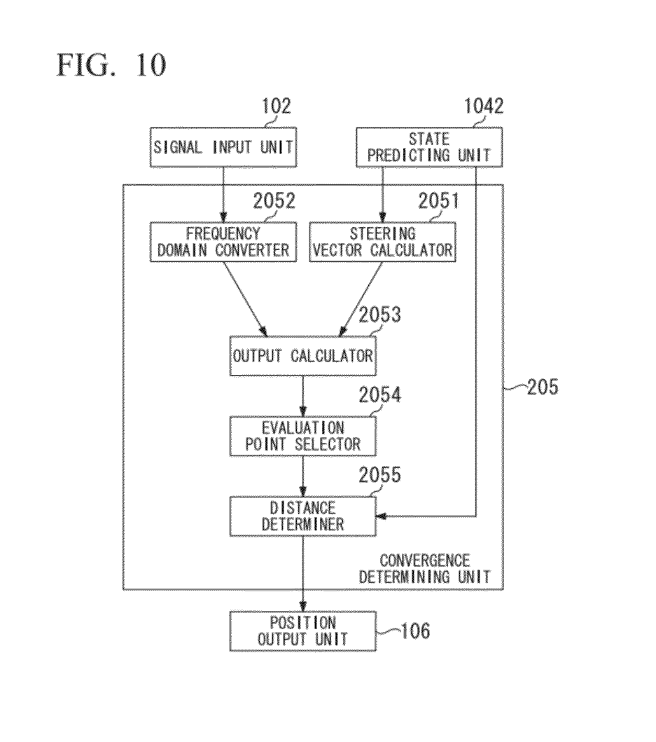

FIG. 10 is a diagram schematically illustrating the configuration of the convergence determining unit 205 according to this embodiment.

The convergence determining unit 205 includes a steering vector calculator 2051, a frequency domain converter 2052, an output calculator 2053, an estimated point selector 2054, and a distance determiner 2055. According to this configuration, the convergence determining unit 205 compares the sound source position included in the sound source state information input from the state estimating unit 104 with the estimated point estimated through the use of a delay-and-sum beam-forming (DS-BF) method. Here, the convergence determining unit 205 determines whether the sound source state information converges based on the estimated point and the sound source position.

The steering vector calculator 2051 calculates the distance D_{n,1} from the position (m^{m}ₓ′, mⁿ_{y}′) of the sound pickup unit 101-n indicated by the sound source state information η_{l|l-1}′ input from the state predicting unit 1042 to the candidate (hereinafter, referred to as the estimated point) ζₛ″ of the sound source position. The steering vector calculator 2051 uses, for example, Equation 2 to calculate the distance D_{n,1}. The steering vector calculator 2051 substitutes the coordinates (x″, y″) of the estimated point ζₛ″ for (xₖ, yₖ) in Equation 2. The estimated point ζₛ″ is, for example, a predetermined lattice point and is one of a plurality of lattice points arranged in a space (for example, the listening room 601 shown in FIG. 2) in which the sound source can be arranged.

The steering vector calculator 2051 sums the propagation delay D_{n,1}/c based on the calculated distance D_{n,1} and the estimated observation time error mⁿ_{τ}′ and calculates the estimated observation time t_{n,1}″ for each channel. The steering vector calculator 2051 calculates a steering vector W(ζₛ″, ζₘ′, ω) based on the calculated estimation time difference t_{n,1}″, for example, using Equation 17 for each frequency ω.

W(ζₛ″, ζₘ′, ω)=[exp(−2πj ω t_{1,t}′, . . . , −2πj ω t_{n,1}′, . . . , −2πj ω t_{N,1}′)]^{T} (17)

In Equation 17, ζₘ′ represents a set of the positions of the sound pickup units 101-1 to 101-N. Accordingly, the respective elements of the steering vector W(η′, ω) are a transfer function giving a delay in phase based on the propagation from the sound source to the respective sound pickup unit 101-n in the corresponding channel n (where n is equal to or more than 1 and equal to or less than N). The steering vector calculator 2051 outputs the calculated steering vector W(ζₛ″, 70 ₘ′, ω) to the output calculator 2053.

The frequency domain converter 2052 converts the sound signal Sn for each channel input from the signal input unit 102 from the time domain to the frequency domain and generates a frequency-domain signal S_{n,1}(ω) for each channel. The frequency domain converter 2052 uses, for example, a Discrete Fourier Transform (DFT) as a method of conversion into the frequency domain. The frequency domain converter 2052 outputs the generated frequency-domain signal S_{n,1}(ω) for each channel to the output calculator 2053.

The output calculator 2053 receives the frequency-domain signal S_{n,1}(ω) for each channel from the frequency domain converter 2052 and receives the steering vector W(ζₛ″, ζₘ′, ω) from the steering vector calculator 2051. The output calculator 2053 calculates the inner product P(ζₛ″, ζₘ′, ω) of the input signal vector S₁(ω) having the frequency-domain signals S_{n,1}(ω) as elements and the steering vector W(ζₛ″, ζₘ′, ω). The input signal vector S₁(ω) is expressed by [S_{1,1}(ω), . . . , S_{n,1}(ω), S_{N,1}(ω))^{T}. The output calculator 2053 calculates the inner product P(ζₛ″, ζₘ′, ω), for example, using Equation 18.

P(ζₛ″, ζₘ′, ω)=W(ζₛ″, ζₘ′, ω)*S₁(ω) (18)

In Equation 18, * represents a complex conjugate transpose of a vector or a matrix. According to Equation 18, the phase due to the propagation delay of the channel components of the input signal vector Sₖ(ω) is compensated for and the channel components are synchronized between the channels. The channel components of which the phases are compensated for are added for each channel.

The output calculator 2053 accumulates the calculated inner product P(ζₛ″, ζₘ′, ω) over a predetermined frequency band, for example, using Equation 19 and calculates a band output signal <P(ζₛ″, ζₘ′)>.

$$〈 P ( {ξ}_{s}^{″} , {ξ}_{m}^{′} ) 〉 = {\sum }_{ω = {ω}_{l}}^{{ω}_{h}} P ( {ξ}_{s}^{″} , {ξ}_{m}^{′} , ω ) \qquad ( 19 )$$

Equation 19 represents the lowest frequency ωl (for example, 200 Hz) and the highest frequency ωh (for example, 7 kHz).

The output calculator 2053 outputs the calculated band output signal <P(ζₛ″, ζₘ+)> to the estimated point selector 2054.

The estimated point selector 2054 selects an estimated point ζₛ″ at which the absolute value of the band output signal <P(ζₛ″, ζₘ′)> input from the output calculator 2053 is maximized as the evaluation value. The estimated point selector 2054 outputs the selected estimated point ζₛ″ to the distance determiner 2055.

The distance determiner 2055 determines that the estimated position converges, when the distance between the estimated point ζₛ″ input from the estimated point selector 2054 and the sound source position (x_{l|l-1}′, y_{l|l-1′}) indicated by the sound source state information η_{l|l-1}′ input from the state predicting unit 1042 is smaller than a predetermined threshold value, for example, the interval of the lattice points. When it is determined that the estimated position converges, the distance determiner 2055 outputs the sound source convergence information indicating that the estimated position of the sound source converges to the position output unit 106. The distance determiner 2055 outputs the input sound source state information to the position output unit 106.

The flow of the convergence determining process in the convergence determining unit 205 will be described below.

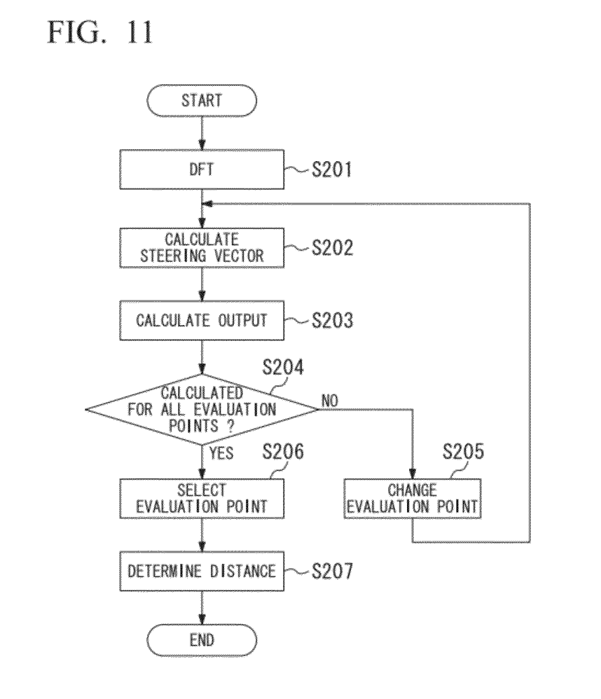

FIG. 11 is a flowchart illustrating the flow of the convergence determining process according to this embodiment.

(Step S201) The frequency domain converter 2052 converts the sound signal Sₙ for each channel input from the signal input unit 102 from the time domain to the frequency domain and generates the frequency-domain signal S_{n,1}(ω) for each channel. The frequency domain converter 2052 outputs the frequency-domain signal S_{n,1}(ω) for each channel to the output calculator 2053. Thereafter, the flow of processes goes to step S202.

(Step S202) The steering vector calculator 2051 calculates the distance D_{n,1} from the position (mⁿₓ′, mⁿ_{y}′) of the sound pickup unit 101-n indicated by the sound source state information input from the state estimating unit 104 to the estimated point ζₛ″. The steering vector calculator 2051 adds the estimated observation time error mⁿ_{τ} to the propagation delay D_{n,1}/c based on the calculated distance D_{n,1} and calculates the estimated observation time t_{n,1}″ for each channel. The steering vector calculator 2051 calculates the steering vector W(ζₛ″, ζₘ′, ω)) based on the calculated time difference t_{n,1}″. The steering vector calculator 2051 outputs the calculates steering vector W(ζₛ″, ζₘ′, ω) to the output calculator 2053. Thereafter, the flow of processes goes to step S203.

(Step S203) The output calculator 2053 receives the frequency-domain signal S_{n,1}(ω) for each channel from the frequency domain converter 2052 and receives the steering vector W(ζₛ″, ζₘ′, ω) from the steering vector calculator 2051. The output calculator 2053 calculates the inner product P(ζₛ″, ζₘ′, ω) of the input signal vector S₁(ω) having the frequency-domain signal S_{n,1}(ω) as elements and the steering vector W(ζₛ″, ζₘ═, ω), for example, using Equation 18.

The output calculator 2053 accumulates the calculated inner product P(ζₛ″, ζₘ′, ω) over a predetermined frequency band, for example, using Equation 19 and calculates the output signal <P(ζₛ″, ζₘ′)>. The output calculator 2053 outputs the calculated output signal <P(ζₛ″, ζₘ′)> to the estimated point selector 2054. Thereafter, the flow of processes goes to step S204.

(Step S204) The output calculator 2053 determines whether the output signal <P(ζₛ″, ζₘ′)> is calculated for all the estimated points. When it is determined the output signal is calculated for all the estimated points (Yes in step S204), the flow of processes goes to step S206. When it is determined that the output signal is not calculated for all the estimated points (No in step S204), the flow of processes goes to step S205.

(Step S205) The output calculator 2053 changes the estimated point for which the output signal <P(ζₛ″, ζₘ′)> is calculated to another estimated point for which the output signal is not calculated. Thereafter, the flow of processes goes to step S202.

(Step S206) The estimated point selector 2054 selects the estimated point ζₛ″ at which the absolute value of the output signal <P(ζₛ″, ζₘ′)> input from the output calculator 2053 is maximized as the evaluation value. The estimated point selector 2054 outputs the selected estimated point ζₛ″ to the distance determiner 2055. Thereafter, the flow of processes goes to step S207.

(Step S207) The distance determiner 2055 determines that the estimated position converges, when the distance between the estimated point ζₛ″ input from the estimated point selector 2054 and the sound source position (x_{l|l-1}′, y_{l|l-1}′) indicated by the sound source state information η_{l|l-1}′ input from the state estimating unit 104 is smaller than a predetermined threshold value, for example, the interval between the lattice points. When it is determined that the estimated position converges, the distance determiner 2055 outputs the sound source convergence information indicating that the estimated position of the sound source converges to the position output unit 106. The distance determiner 2055 outputs the input sound source state information to the position output unit 106. Thereafter, the flow of processes is ended.

The result of verification using the sound source position estimation apparatus 2 according to this embodiment will be described below.

In the verification, a soundproof room with a size of 4 m×5 m×2.4 m is used as the listening room. 8 microphones as the sound pickup units 101-1 to 101-N are arranged at random positions in the listening room. In the listening room, an experimenter claps his hands while walking. In the experiment, this clap is used as a sound source. Here, the experiment clap his hands every 5 steps. The stride of each step is 0.3 m and the time interval is 0.5 seconds. The rectangular movement model and the circular movement model are assumed as the movement model of the sound source. When the rectangular movement model is assumed, the experimenter walks on the rectangular track of 1.2 m×2.4 m. When the circular movement model is assumed, the experimenter walks on a circular track with a radius of 1.2 m. Based on this experiment setting, the sound source position estimation apparatus 2 is made to estimate the position of the sound source, the positions of 8 microphones, and the observation time errors between the microphones.

In the operating conditions of the sound source position estimation apparatus 2, the sampling frequency of a sound signal is set to 16 kHz. The window length as a process unit is set to 512 samples and the shift length of a process window is set to 160 samples. The standard deviation in observation error of the arrival time from a sound source to the respective sound pickup units is set to 0.5×10⁻³, the standard deviation in position of the sound source is set to 0.1 m, and the standard deviation in observation direction of a sound source is set to 1 degree.

FIG. 12 is a diagram illustrating an example of a temporal variation of the estimation error.

The estimation error of the position of a sound source, the estimation error of the position of sound pickup units, and the observation time error when a rectangular movement model is assumed as the movement model are shown in part (a), part (b), and part (c) of FIG. 12, respectively.

The vertical axis of part (a) of FIG. 12 represents the estimation error of the sound source position, the vertical axis of part (b) of FIG. 12 represents the estimation error of the position of the sound pickup unit, and the vertical axis of part (c) of FIG. 12 represents the observation time error. Here, estimation error shown in part (b) of FIG. 12 is an average value of the absolute values of N sound pickup units. The observation time error shown in part (c) of FIG. 12 is an average value of the absolute values of N−1 sound pickup units. In FIG. 12, the horizontal axis represents the time. The unit of the time is the number of handclaps. That is, the number of handclaps in the horizontal axis is a reference of time.

In FIG. 12, the estimation error of the sound source position has a value of 2.6 m larger than the initial value 0.5 m just after the operation is started, but converges to substantially 0 with the lapse of time. Here, in the course of convergence, vibration with the lapse of time is recognized. This vibration is considered due to the nonlinear variation of the movement direction of the sound source in the rectangular movement model. The estimation error of the sound source position enters the amplitude range of the vibration within 10 times of handclap.

The estimation error of the sound pickup positions converges substantially monotonously to 0 with the lapse of time from the initial value of 0.9 m. The estimation error of the observation time error converges substantially to 2.4×10⁻³ s, which is smaller than the initial value 3.0×10⁻³ s, with the lapse of time.

Therefore, according to FIG. 12, all the sound source position, the sound pickup positions, and the observation time error are estimated with the lapse of time with high precision.

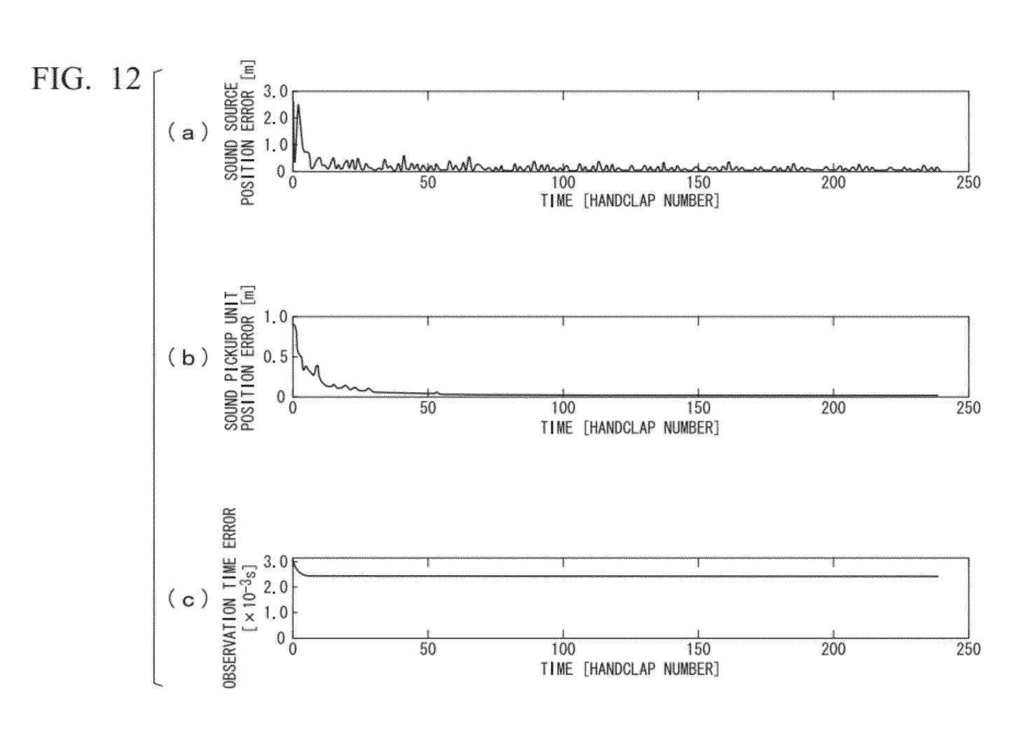

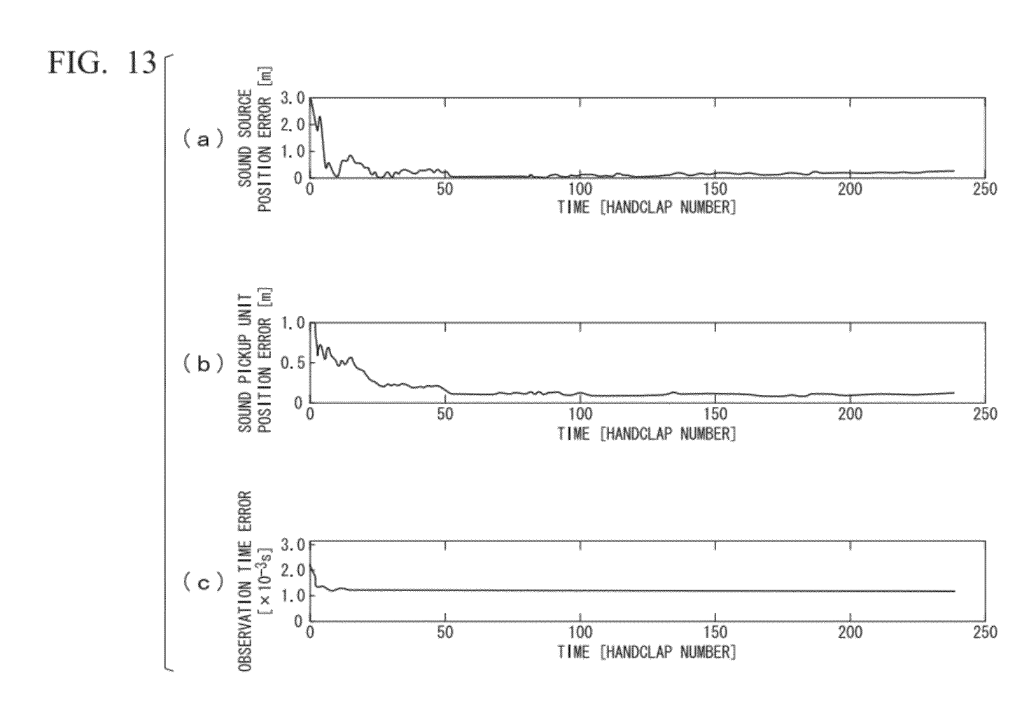

FIG. 13 is a diagram illustrating another example of a temporal variation of the estimation error.

The estimation error of the position of a sound source, the estimation error of the position of sound pickup units, and the observation time error when a circular movement model is assumed as the movement model are shown in part (a), part (b), and part (c) of FIG. 13, respectively.

The vertical axis and the horizontal axis in part (a), part (b), and part (c) of FIG. 13 are the same as shown in part (a), part (b), and part (c) of FIG. 12.

In FIG. 13, the estimation error of the sound source position converges substantially to 0 with the lapse of time from the initial value 3.0 m. The estimation error reaches 0 by 10 handclaps. Here, by 50 handclaps, the estimation error vibrates with a period longer than that of the rectangular movement model.

The estimation error of the sound pickup position converges to a value of 0.1, which is much smaller than the initial value 1.0 m, with the lapse of time. Here, after approximately 14 handclaps, the estimation error of the sound source position and the estimation error of the sound pickup position tend to increase.

The estimation error of the observation time error converges substantially to 1.1×10⁻³ s, which is smaller than the initial value 2.4×10⁻³ s, with the lapse of time.

Therefore, according to FIG. 13, the sound source position, the sound pickup positions, and the observation time error are estimated more precisely with the lapse of time.

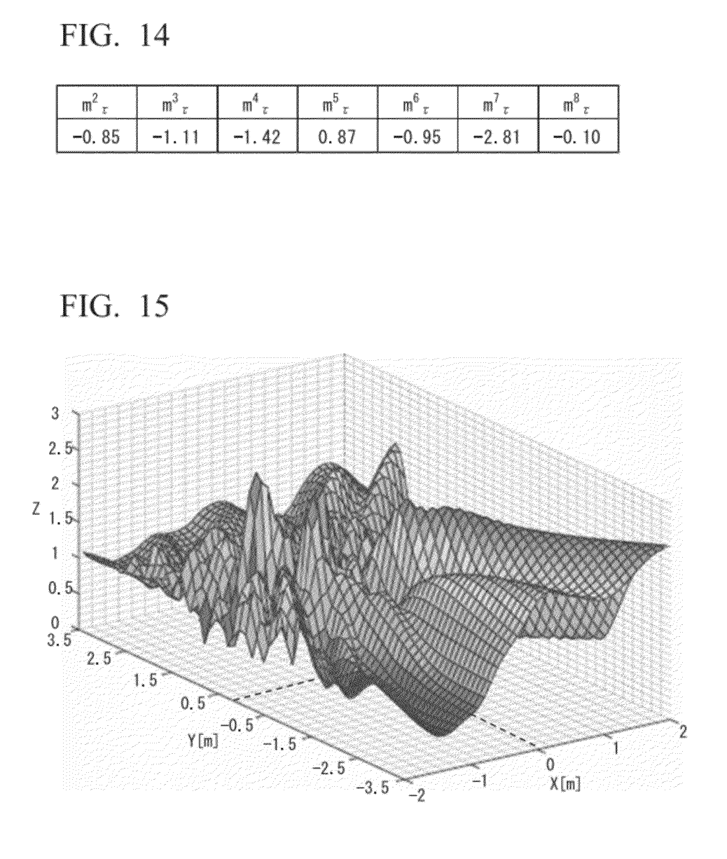

FIG. 14 is a table illustrating an example of the observation time error.

The observation time error shown in FIG. 14 is a value estimated on the assumption of the circular movement model and exhibits convergence with the lapse of time.

FIG. 14 represents the observation time error m²_{τ} of the sound pickup unit 101-2 to the observation time error m⁸_{τ} of the sound pickup unit 101-8 for channels 2 to 8 sequentially from the leftmost to the right. The unit of the values is 10⁻³ seconds. The observation time errors m²_{τ} to m⁸_{τ} are −0.85, −1.11, −1.42, 0.87, −0.95, −2.81, and −0.10.

FIG. 15 is a diagram illustrating an example of sound source localization.

In FIG. 15, the X axis represents the coordinate axis in the horizontal direction of the listening room 601, the Y axis represents the coordinate axis in the vertical direction, and the Z axis represents the power of the band output signal. The origin represents the center of the X-Y plane of the listening room 601. The dotted lines indicating X=0 and Y=0 are shown in the X-Y plane of FIG. 15.

The power of the band output signal shown in FIG. 15 is a value calculated for each estimated point based on the initial values of the positions of the sound pickup units 101-1 to 101-N by the estimated point selector 2054. This value greatly varies depending on the estimated points. Accordingly, the estimated point having a peak value has no significant meaning as a sound source position.

FIG. 16 is a diagram illustrating another example of sound source localization.

In FIG. 16, the X axis, the Y axis, and the Z axis are the same as in FIG. 15.

The power of the band output signal shown in FIG. 16 is a value calculated for each estimated point based on the estimated positions of the sound pickup units 101-1 to 101-N after convergence when the sound source is located at the origin. This value has a peak value at the origin.

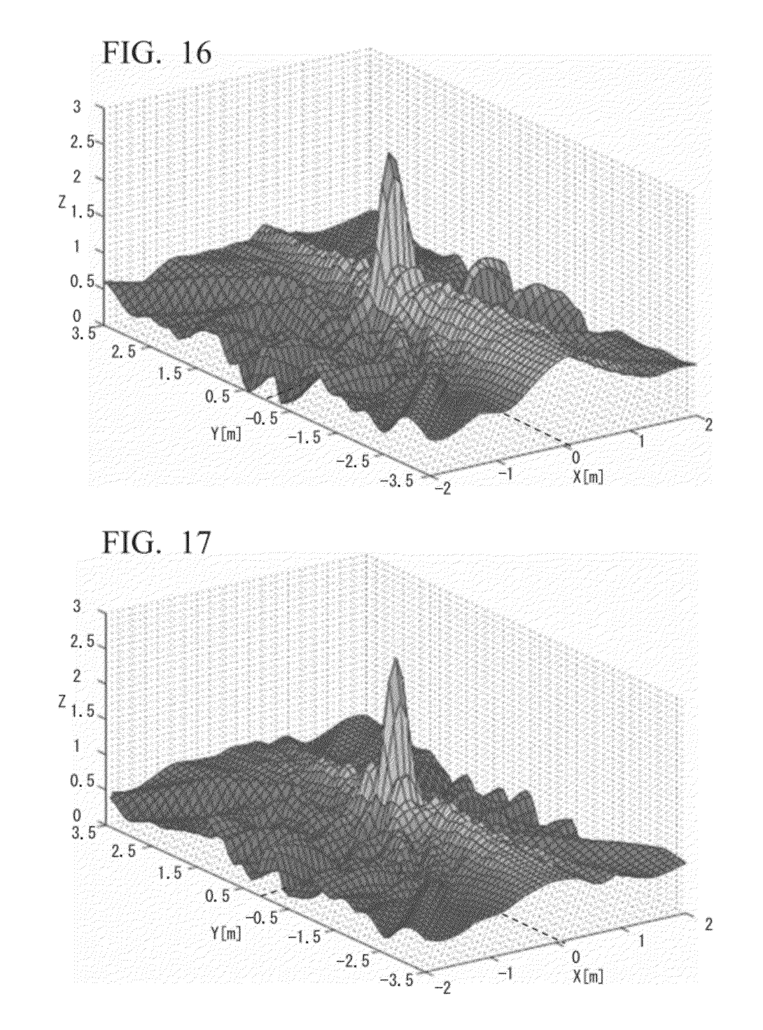

FIG. 17 is a diagram illustrating another example of sound source localization.

In FIG. 17, the X axis, the Y axis, and the Z axis are the same as in FIG. 15.

The power of the band output signal shown in FIG. 17 is a value calculated for each estimated point based on the positions of the actual sound pickup units 101-1 to 101-N when the sound source is located at the origin. This value has a peak value at the origin. In consideration of the result of FIG. 16, it can be seen that the estimated point having the peak value of the band output signal is correctly estimated as the sound source position using the estimated positions of the sound source units after convergence.

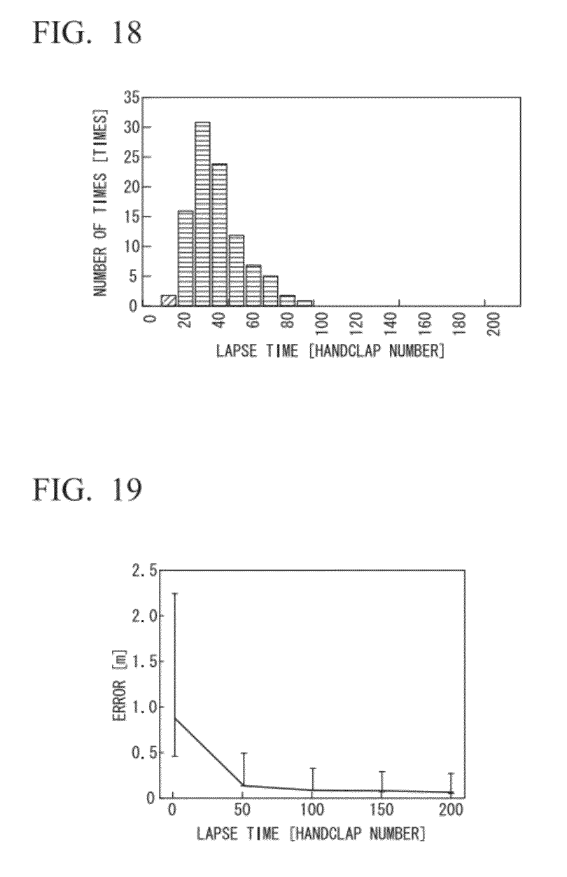

FIG. 18 is a diagram illustrating an example of the convergence time.

FIG. 18 shows a bar graph in which the horizontal axis represents the elapsed time zone until the sound source position converges and the vertical axis represents the number of experiment times for each elapsed time zone. Here, the convergence means a time point when the variation of the estimated sound source position from the previous time l−1 to the present time l is smaller than 0.01 m. The total number of experiments is 100. The positions of the sound pickup units 101-1 to 101-8 are randomly changed for each experiment.

In FIG. 18, when the elapsed time zones are 10 to 19, 20 to 29, 30 to 39, 40 to 49, 50 to 59, 60 to 69, 70 to 79, 80 to 89, and 90 to 99 (all of which represent the number of handclaps), the numbers of experiment times are 2, 16, 31, 24, 12, 7, 5, 2, and 1. In the other elapsed time zones, the number of experiment times is 0.

FIG. 19 is a diagram illustrating an example of the error of the estimated sound source positions.

In FIG. 19, the horizontal axis represents the lapse time and the vertical axis represents the error of the sound source position every lapse time. FIG. 19 shows a polygonal line graph connecting the averages of the lapse times and an error bar connecting the maximum values and the minimum values of the lapse times.

In FIG. 19, when the elapsed times are 0, 50, 100, 150, and 200 (all of which represent the number of handclaps), the average values are 0.9, 0.13, 0.1, 0.08, and 0.07 m. This means that the error converges with the lapse of time. When the elapsed times are 0, 50, 100, 150, and 200 (all of which represent the number of handclaps), the maximum values are 2.26, 0.5, 0.4, 0.35, and 0.3 m and the minimum values are 0.47, 0.10, 0.09, 0.07, and 0.06 m. Accordingly, with the lapse of time, it can be seen that the difference between the maximum value and the minimum value decreases and the sound source position is stably estimated.

In this manner, according to this embodiment, the estimated point at which the evaluation value obtained by summing the signals, which are obtained by compensating for the input signals of a plurality of channels with the phases from the estimated point of a predetermined sound source position to the positions of the microphones corresponding to the plurality of channels, is maximized is determined. In this embodiment, the convergence determining unit determining whether the variation in the sound source position converges based on the distance between the determined estimated point and the sound source position indicated by the sound source state information is provided. Accordingly, it is possible to estimate an unknown sound source position along with the positions of the sound pickup units while recording the sound signals. It is possible to stably estimate the sound source position and to improve the estimation precision.

Although it has been described that the position of the sound source indicated by the sound source state information or the positions of the sound pickup units 101-1 to 101-N are coordinate values in the two-dimensional orthogonal coordinate system, this embodiment is not limited to this example. In this embodiment, a three-dimensional orthogonal coordinate system may be used instead of the two-dimensional coordinate system, or a polar coordinate system or any coordinate system representing other variable spaces may be used. When coordinate values expressed by the three-dimensional coordinate system are treated, the number of channels N in this embodiment is set to an integer greater than 3.

Although it has been described that the movement model of a sound source includes the circular movement model and the rectangular movement model, this embodiment is not limited to the example, in this embodiment, other movement models such as a linear movement model and a sinusoidal movement model may be used.

Although it has been described that the position output unit 106 outputs the sound source position information included in the sound source state information input from the convergence determining unit 105, this embodiment is not limited to this example. In this embodiment, the sound source position information and the movement direction information included in the sound source state information, the position information of the sound pickup units 101-1 to 101-N, the observation time error, or combinations thereof may be output.

It has been described that the convergence determining unit 205 determines whether the sound source state information converges based on the estimated point estimated through the delay-and-sum beam-forming method and the sound source position included in the sound source state information input from the state estimating unit 104. However, this embodiment is not limited to this example. In this embodiment, the sound source position estimated through the use of other methods such as a MUSIC (Multiple Signal Classification) method instead of the estimated point estimated through the use of the delay-and-sum beam-forming method may be used as an estimated point.

The example where the distance determiner 2055 outputs the input sound source state information to the position output unit 106 has been described above, but this embodiment is not limited to this example. In this embodiment, estimated point information indicating the estimated points and being input from the estimated point selector 2054 may be output instead of the sound source position information included in the sound source state information.

A part of the sound source position estimation apparatus 1 and 2 according to the above-mentioned embodiments, such as the time difference calculating unit 103, the state updating unit 1041, the state predicting unit 1042, the convergence determining unit 105, the steering vector calculator 2051, the frequency domain converter 2052, the output calculator 2053, the estimated point selector 2054, and the distance determiner 2055 may be embodied by a computer. In this case, the part may be embodied by recording a program for performing the control functions in a computer-readable recording medium and causing a computer system to read and execute the program recorded in the recording medium. Here, the “computer system” is built in the sound source position estimation apparatus 1 and 2 and includes an OS or hardware such as peripherals. Examples of the “computer-readable recording medium” include memory devices of portable mediums such as a flexible disk, a magneto-optical disc, a ROM, and a CD-ROM, a hard disk built in the computer system, and the like. The “computer-readable recording medium” may include a recording medium dynamically storing a program for a short time like a transmission medium when the program is transmitted via a network such as the Internet or a communication line such as a phone line and a recording medium storing a program for a predetermined time like a volatile memory in a computer system serving as a server or a client in that case. The program may embody a part of the above-mentioned functions. The program may embody the above-mentioned functions in cooperation with a program previously recorded in the computer system. In addition, part or all of the sound source position estimation apparatus 1 and 2 according to the above-mentioned embodiments may be embodied as an integrated circuit such as an LSI (Large Scale Integration). The functional blocks of the sound source position estimation apparatus 1 and 2 may be individually formed into processors and a part or all thereof may be integrated as a single processor. The integration technique is not limited to the LSI, but they may be embodied as a dedicated circuit or a general-purpose processor. When an integration technique taking the place of the LSI appears with the development of semiconductor techniques, an integrated circuit based on the integration technique may be employed.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A sound source position estimation apparatus comprising:
a signal input unit that receives sound signals of a plurality of channels;
a time difference calculating unit that calculates a time difference between the sound signals of the channels;
a state predicting unit that predicts present sound source state information from previous sound source state information which is sound source state information including a position of a sound source; and
a state updating unit that estimates the sound source state information so as to reduce an error between the time difference calculated by the time difference calculating unit and the time difference based on the sound source state information predicted by the state predicting unit.

2. The sound source position estimation apparatus according to claim 1, wherein the state updating unit calculates a Kalman gain based on the error and multiplies the calculated Kalman gain by the error.

3. The sound source position estimation apparatus according to claim 1, wherein the sound source state information includes positions of sound pickup units supplying the sound signals to the signal input unit.

4. The sound source position estimation apparatus according to claim 3, further comprising a convergence determining unit that determines whether a variation in position of the sound source converges based on the variation in position of the sound pickup units.

5. The sound source position estimation apparatus according to claim 3, further comprising a convergence determining unit that determines an estimated point at which an evaluation value, which is obtained by adding signals obtained by compensating for the sound signals of the plurality of channels with a phase from a predetermined estimated point of the position of the sound source to the positions of the sound pickup units corresponding to the plurality of channels, is maximized and that determines whether the variation in position of the sound source converges based on the distance between the determined estimated point and the position of the sound source indicated by the sound source state information estimated by the state updating unit.

6. The sound source position estimation apparatus according to claim 5, wherein the convergence determining unit determines the estimated point using a delay-and-sum beam-forming method and determines whether the variation in position f the sound source converges based on the distance between the determined estimated point and the position of the sound source indicated by the sound source state information estimated by the state updating unit.

7. A sound source position estimation method comprising:
receiving sound signals of a plurality of channels;
calculating a time difference between the sound signals of the channels;
predicting present sound source state information from previous sound source state information which is sound source state information including a position of a sound source; and
estimating the sound source state information so as to reduce an error between the calculated time difference and the time difference based on the predicted sound source state information.

8. A sound source position estimation program causing a computer of a sound source position estimation apparatus to perform the processes of:
receiving sound signals of a plurality of channels;
calculating a time difference between the sound signals of the channels;
predicting present sound source state information from previous sound source state information which is sound source state information including a position of a sound source; and
estimating the sound source state information so as to reduce an error between the calculated time difference and the time difference based on the predicted sound source state information.
